(19) United States
(12) Patent Application Publication
(10) Pub. No.: US 2022/0337058 A1
(43) Pub. Date: Oct. 20, 2022

(54) OPTIMIZING HOME ENERGY EFFICIENCY AND DEVICE UPGRADE SCHEDULING

(71) Applicants: Jinho Kim, KwangJu (KR); Manho Joung, San Diego, CA (US)

(72) Inventors: Jinho Kim, KwangJu (KR); Manho Joung, San Diego, CA (US)

(21) Appl. No.: 17/231,559

(22) Filed: Apr. 15, 2021

(51) Int. Cl. H02J 3/00; G06N 20/00

(52) U.S. Cl. CPC H02J 3/003; G06N 20/00; H02J 2203/20

(57) ABSTRACT

A method, a computer system, and a computer program product for optimizing home energy efficiency and device upgrade scheduling is provided. The present invention may include gathering data about home utilities and energy consumption patterns over time. The present invention may include training a machine learning model based on the gathered data. The present invention may include detecting inefficient devices or utility configurations based on the trained machine learning model. The present invention may include gathering data about current and future advances in home device and energy technology. The present invention may include determining optimal utility configurations and detecting candidate device upgrades. The present invention may include performing cost/benefit analysis based on the determined utility configurations and device upgrades. The present invention may include providing personalized recommendations to the user based on the cost/benefit analysis.

### BACKGROUND

The present invention relates generally to the field of machine learning, and more particularly to optimizing home energy efficiency.

Home energy consumption and costs are determined by device usage patterns and utility costs. Home devices including, but not limited to, televisions, refrigerators, washers, dryers, ovens, stoves, water heaters, and electric vehicles, have differing levels of energy consumption and utility requirements. Homes may have one or more utilities available to deliver energy to these devices, including, but not limited to, electricity, gas, and solar power. Upgrading an appliance/device involves startup costs such as installation fees and rerouting or modification of utility lines connected to the home.

As technology for home devices advances, new models become available that may offer greater energy efficiency than existing models. New models may also require specific utility configurations and infrastructure that may or may not be available at all geographic locations. Decisions about whether or not to upgrade a device must balance utility availability and installation costs with the long-term benefits of improved energy efficiency.

### SUMMARY

Embodiments of the present invention disclose a method, a computer system, and a computer program product for optimizing home energy efficiency and device upgrade scheduling. The present invention may include gathering data about home utilities and energy consumption patterns over time. The present invention may include training a machine learning model based on the gathered data. The present invention may include detecting inefficient devices based on the trained machine learning model. The present invention may include gathering data about current and future advances in home device and energy technology. The present invention may include determining optimal utility configurations and detecting candidate device upgrades. The present invention may include performing cost/benefit analysis based on the determined device upgrades. The present invention may include providing specialized recommendations to the user based on the cost/benefit analysis.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of an energy optimization system according to at least one embodiment;

FIG. 2 is an operational flowchart illustrating a process for analyzing energy fundamentals according to at least one embodiment;

FIG. 3 is an operational flowchart illustrating a process for energy consumption prediction according to at least one embodiment;

FIG. 4 is an operational flowchart illustrating a process for personalized energy management according to at least one embodiment; and

FIG. 5 is a block diagram of an illustrative cloud computing environment in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following exemplary embodiments provide a system, method and computer program product for optimizing home energy efficiency and device upgrade scheduling. As such, the present embodiment has the capacity to improve the technical field of machine learning optimization systems by analyzing home energy consumption patterns, determining an optimal utility and device configuration, and recommending upgrades to the user. More specifically, the present invention may include gathering data about home utilities and energy consumption patterns over time. The present invention may include gathering data about current and future advances in home device and energy technology. The present invention may include training a machine learning model based on the gathered data. The present invention may include detecting inefficient devices based on the trained machine learning model. The present invention may include determining optimal utility configurations and detecting candidate appliance upgrades. The present invention may include performing cost/benefit analysis based on the determined device upgrades. The present invention may include providing specialized recommendations to the user based on the cost/benefit analysis.

As previously described, home energy consumption and costs are determined by device usage patterns and utility costs. Home devices including, but not limited to, televisions, refrigerators, washers, dryers, ovens, stoves, water heaters, and electric vehicles, have differing levels of energy consumption and utility requirements. Homes may have one or more utilities available to deliver energy to these devices, including, but not limited to, electricity, gas, and solar power. Upgrading a device involves startup costs such as installation fees and rerouting or modification of utility lines connected to the home.

As technology for home devices advances, new models become available that may offer greater energy efficiency than existing models. New models may also require specific utility configurations and infrastructure that may or may not be available at all geographic locations.

There may be particular instances when a home device must be replaced; for example, due to malfunction of the existing device, or degradation of the device's energy efficiency over time, leading to increased utility costs. However, the decisions about which devices to upgrade, which newer models to choose, and when to perform the upgrades require complex cost/benefit analysis. These decisions are often made with incomplete information. This may lead to excessive costs and reduced benefits obtained by upgrading to suboptimal models or upgrading at a suboptimal time. At worst, large costs may be sunk into upgrades that are incompatible with the house's current utility configuration, necessitating further costly infrastructure upgrades or wasted effort. It is difficult for consumers who are not experts to make informed decisions without detailed knowledge of the valid options that are available and prospective future technologies that may provide increased benefit over time.

Therefore, it may be advantageous to, among other things, analyze energy consumption patterns of the home, detect high-cost or inefficient devices, determine optimal replacement models for those devices that are compatible with the house's utility configuration, and determine an optimal timeline for upgrading the devices based on cost/benefit analysis.

According to at least one embodiment, the present invention may improve a home's energy efficiency by determining an optimal schedule for home device upgrades, given the home's energy consumption patterns and available utilities.

According to at least one embodiment, the present invention may gather data about a home's energy consumption. Gathered data may include, but are not limited to, utility usage per hour, weather conditions, time of day, date, and geographical location.

According to at least one embodiment, the present invention may include a trained machine learning model which utilizes the gathered data to detect high cost and inefficient devices.

According to at least one embodiment, the present invention may include gathering data about current and future advances in home device and energy technology compatible with the house's utility configuration. The gathered data may also include utility upgrades to expand the list of available device models.

According to at least one embodiment, the present invention may perform an analysis to determine optimal device upgrades and timing to minimize cost and maximize the energy efficiency of the home. The analysis may be used to provide recommendations to the user.

The recommendations and instructions for device upgrades may be provided on a user dashboard. The user dashboard may show the inefficient devices, recommended new models, and expected installation costs and future savings obtained by performing the recommended upgrades.

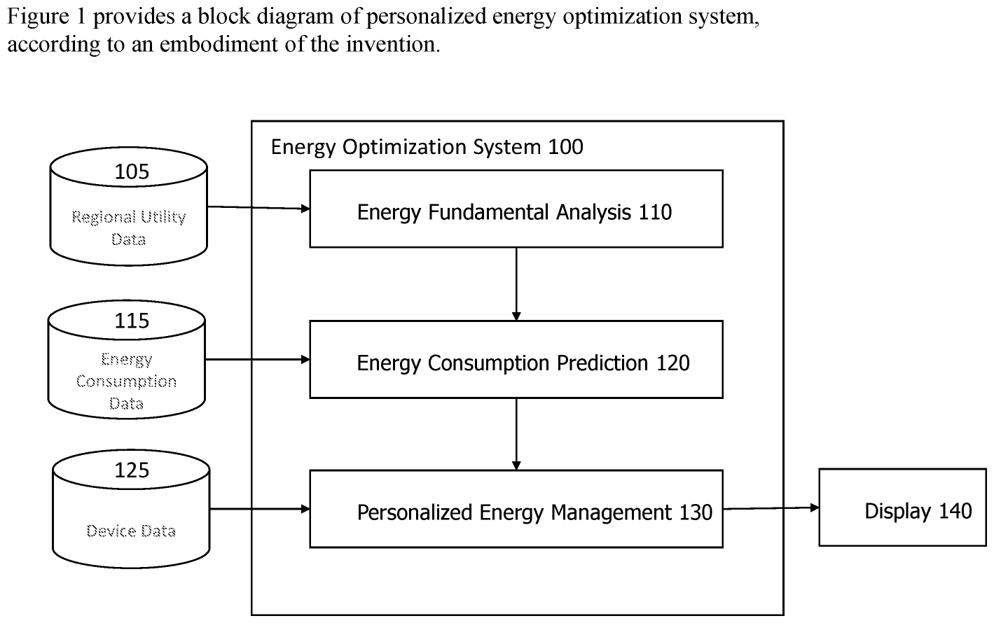

Referring to FIG. 1, an exemplary energy optimization system 100 in accordance with one embodiment is depicted. FIG. 1 provides only an illustration of one embodiment of the present invention and does not imply any limitations with regard to the environments in which different embodiments may be implemented. In the depicted embodiment, energy optimization system 100 may include an energy fundamental analysis module 110 configured to receive regional utility data from database 105. The energy optimization system 100 may also include an energy consumption prediction module 120 configured to receive energy consumption data from database 115 and output data from energy fundamental analysis module 110. The energy optimization system 100 may also include a personalized energy management module 130 configured to receive device data from database 125 and output data from energy consumption prediction module 120. The output from the personalized energy management module 130 may be sent to display 140. The output from the personalized energy management module 130 shown on display 140 may include recommendations and timelines for home device upgrades, utility modifications, and projected costs and savings resulting from those recommendations.

Regional utility data 105 may include data relevant to the specific location of the target home. This may include information on which utilities are available at the location, weather patterns throughout the year, costs of the available utilities, tax considerations, and risk of natural disasters, among other things. The data 105 may be obtained from online sources using a machine learning algorithm. This machine learning algorithm may include a natural language processing algorithm. The data 105 may be used by energy fundamental analysis module 110 to train a machine learning model to predict energy consumption and cost trends throughout the year at the specified location. The machine learning model may be a time series deep learning model or a reinforcement learning model.

The time series deep learning model or reinforcement learning model may learn and predict the expected energy consumption of a home at the specified location depending on the time of day and day of the year.

The time series deep learning model or reinforcement learning model may learn and predict the expected energy costs per utility of a home at the specified location depending on the time of day and day of the year.

Energy consumption data 115 may include data specific to the target home. This may include hourly utility consumption rates and manufacturer and model information for home devices that consume significant amounts of energy. This may include, but is not limited to, heating systems, water heaters, stoves, ovens, refrigerators, televisions, computers, and electric vehicles. Hourly or 15-minute utility usage rate data may be obtained from the utility providers. This data may be used together with the output from energy fundamental analysis module 110 to train a machine learning model to predict hourly energy consumption and costs per home device at the home. The machine learning model may be a time series deep learning model or a reinforcement learning model.

Device data 125 may include a list of the costs, energy consumption rates, and utility requirements of device models that could replace the devices contained in data 115. Data 125 may be obtained from online sources using a machine learning algorithm. The machine learning algorithm may include a natural language processing algorithm.

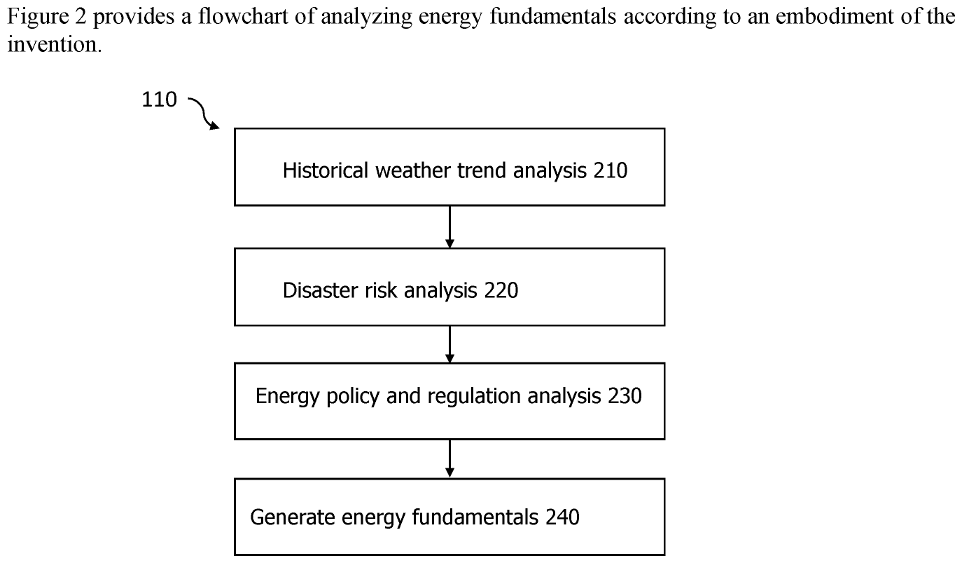

Referring now to FIG. 2, an operational flowchart illustrating the exemplary energy fundamental analysis module 110 used by the energy optimization system 100 according to at least one embodiment is depicted.

At 210, the energy fundamental analysis module 110 may gather data about local weather patterns in the geographical area of the home. Data about weather patterns may include, but is not limited to, daily temperature graphs, chance of precipitation, and expected hours of sunlight. Local weather data may be gathered from the online databases of local weather services. Weather data may be parsed with a machine learning program that may include a natural language processing algorithm.

At 220, the energy fundamental analysis module 110 may gather historical data about natural disasters in the geographical area of the home. Data about natural disasters may include, but is not limited to, seismic activity, flood warnings, fires, tropical storms and hurricanes. Natural disaster data may be gathered from online databases and may be parsed with a machine learning program that may include a natural language processing algorithm.

At 230, the energy fundamental analysis module 110 may gather data about government policies and regulations affecting the utility costs of the home. Energy policy data may include, but is not limited to, tax incentives for installing solar panels, rates for electricity versus natural gas, and upcoming regulations affecting cost balancing of different utilities available to the home. Energy policy data may be gathered from online databases of news and government websites. Energy policy data may be parsed with a machine learning program that may include a natural language processing algorithm.

At 240, energy fundamental analysis module 110 consolidates the local weather data 210, natural disaster data 220, and energy policy data 230, and trains a machine learning algorithm that models and predicts the expected energy consumptions rates and costs for the home per hour of the day and day of the year. The machine learning model may be a deep learning time series model or a reinforcement learning model.

The time series deep learning model may be a Recurrent Neural Network (“RNN”), a Temporal Convolution Network (“TCN”), or a Long Short-Term Memory (“LSTM”). The reinforcement learning model may be a Deep Q Network (“DQN”). The energy fundamental analysis module 110 may train the RNN, TCN, LSTM or DQN based on the gathered data. The RNN, TCN, LSTM or DQN may identify expected energy consumption and costs per time of day and day of the year.

An RNN, TCN or LSTM is a type of neural network that may be well-suited to time series data. The neural networks may perform the same task for every element of a sequence, with the output being dependent on previous computations.

A DQN is a type of neural network that may be well-suited to sequential decision-making tasks. The network may learn optimal decision-making patterns through delayed reward optimization of sequential decisions.

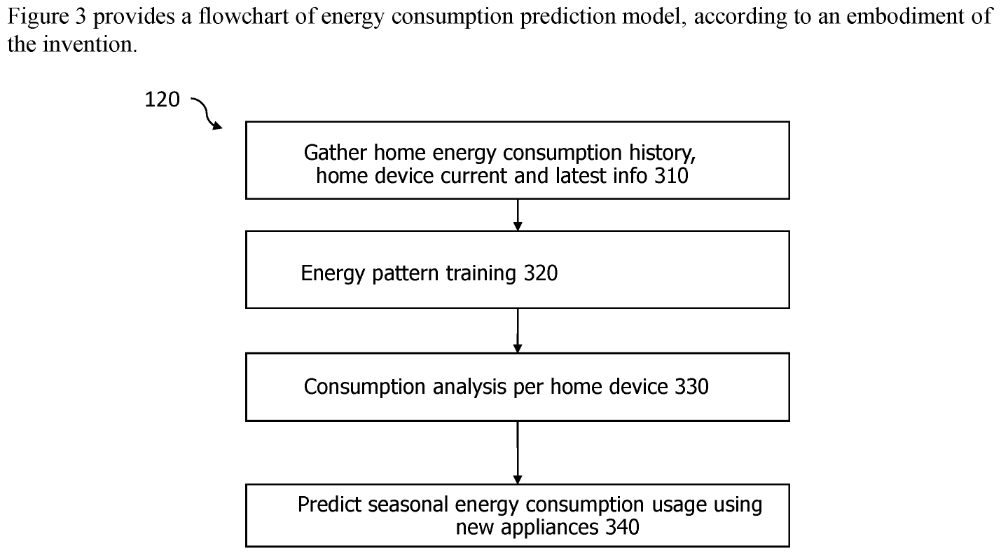

Referring now to FIG. 3, an operational flowchart illustrating the exemplary energy consumption prediction module 120 used by the energy optimization system 100 according to at least one embodiment is depicted.

At 310, the energy consumption prediction module 120 may gather historical hourly or 15-minute home energy consumption data, manufacturer and model name for home devices with significant energy usage, and data on candidate new models to replace the current home devices. Hourly or 15-minute energy consumption data may be gathered from the home's utility service providers. Data on current devices may be manually entered by the user. Data on candidate new models may be gathered from online manufacturer resources. Data on new models may be parsed with a machine learning program that may include a natural language processing algorithm.

At 320, the energy consumption prediction module 120 may train a machine learning algorithm to model and predict energy consumption patterns for the home using the gathered energy consumption data 310. The machine learning model may predict energy consumption per hour of the day and day of the year. The machine learning model may be a time series deep learning model or a reinforcement learning model.

At 330, the energy consumption prediction module 120 may train a machine learning algorithm to identify which devices are responsible for the majority of energy consumption at each hour of the day and day of the year using the device data 310 and the output of machine learning model 320. The machine learning model may be a time series deep learning model or a reinforcement learning model.

At 340, the energy consumption prediction module 120 may use machine learning model 330 and the data on new models 310 to predict home energy consumption with various combinations of device upgrades. The module may produce a range of cost/energy consumption options with various device upgrade options.

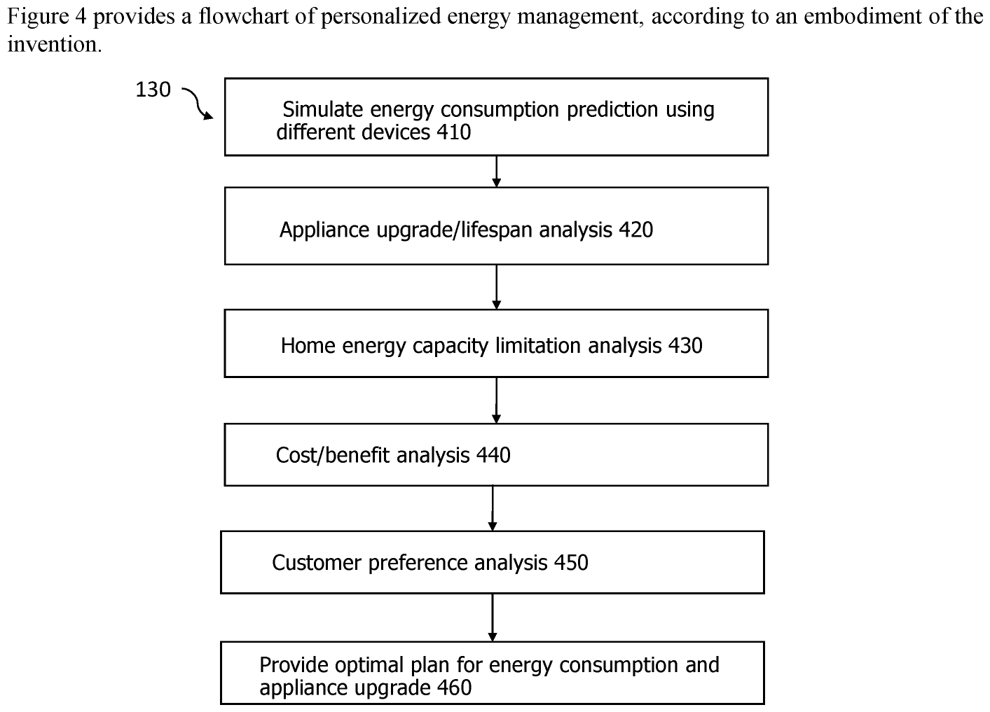

Referring now to FIG. 4, an operational flowchart illustrating the exemplary personalized energy management module 130 used by the energy optimization system 100 according to at least one embodiment is depicted.

At 410, the personalized energy management module 130 may predict energy cost and consumption with a range of device models using the device data 125 and the time series deep learning model or reinforcement learning model of the energy consumption analysis module 120. Module 410 may produce a list of candidate device sets with predicted cost and energy consumption values.

At 420, the personalized energy management module 130 may calculate expected upgrade costs and lifespans of the alternative device options proposed by module 410 using the gathered device data 125. The upgrade costs and device lifespans may be used to refine the list of candidate device sets produced by module 410.

At 430, the personalized energy management module 130 may determine which device options are supported by the home's current utility configuration using the results of sub-module 420 and the gathered device data 125. Supported devices may include those for which the home may need to perform utility upgrades. This may be used to refine the list of candidate device sets produced by module 420.

At 440, the personalized energy management module 130 may perform a cost/benefit analysis on the list of candidate device upgrade sets produced by module 430. The cost/benefit analysis may optimize short, medium, and long-term costs and savings by weighing factors including, but not limited to, installation costs, tax benefits, utility costs and energy consumption rates. The cost/benefit analysis may be used to further refine the list of candidate device sets produced by module 430.

At 450, the personalized energy management module 130 may further refine the list of device sets produced by module 440 by taking into account the preferences of the home user. Preferences may be determined by examining the manufacturers and models of the current devices, or through manual user input.

At 460, the personalized energy management module 130 may present the best options for short, medium, and long-term savings to the home user as produced by module 450. The recommended devices, necessary utility modifications, and upgrade schedules may be provided to the user via display 140 of the energy optimization system 100.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

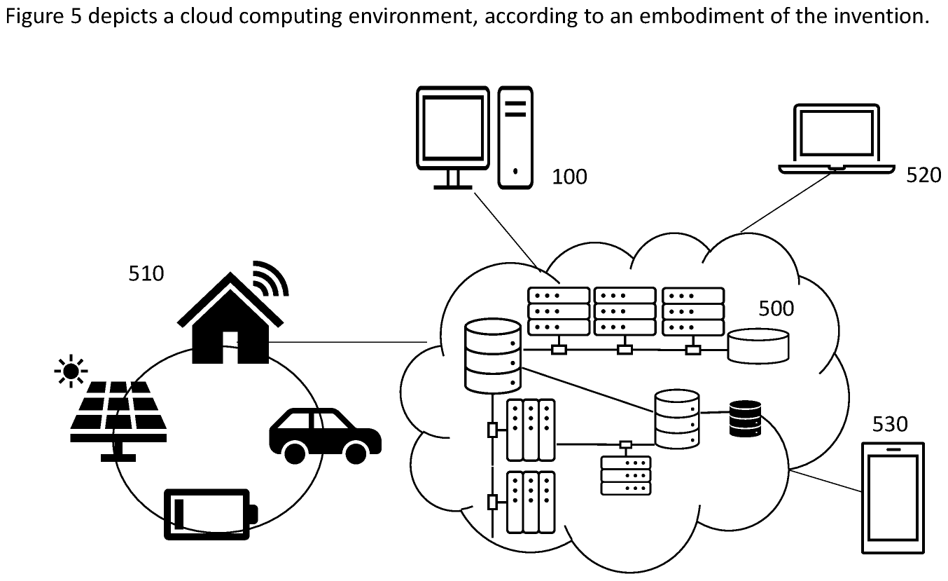

Referring now to FIG. 5, illustrative cloud computing environment 500 is depicted. As shown, cloud computing environment 500 comprises one or more cloud computing nodes with which local computing devices used by cloud consumers, such as, for example, energy optimization system 100, home devices, and automobile computer systems 510, laptop computer 520, and personal digital assistant (PDA) or cellular telephone 530. Nodes may communicate with one another. They may be grouped (not shown) physically or virtually, in one or more networks, such as Private, Community, Public, or Hybrid clouds as described herein above, or a combination thereof. This allows cloud computing environment 500 to offer infrastructure, platforms and/or software as services for which a cloud consumer does not need to maintain resources on a local computing device. It is understood that the types of computing devices 100, 510, 520, and 530 shown in FIG. 5 are intended to be illustrative only and that the computing nodes and cloud computing environment 500 can communicate with any type of computerized device over any type of network and/or network addressable connection (e.g., using a web browser)

What is claimed is:

1. A method for optimizing home energy efficiency and device upgrade scheduling, the method comprising:
gathering utility data for a home;
training machine learning models based on the gathered data;
detecting inefficient devices and utility configurations based on the trained machine learning model;
training a machine learning model to gather data about current and future advances in home device technology;
determining candidate device and utility upgrades;
performing a cost/benefit analysis based on the determined device and utility upgrades; and
providing a recommended device and utility upgrade schedule to the user.

2. The method of claim 1, wherein utility data comprises:
device data including manufacturer and model names of current home devices entered by a user;
regional utility data on available utilities at the home, utility costs and relevant government policies, and weather and natural disaster patterns; and
energy consumption data on hourly energy consumption rates for each utility used at the home.

3. The method of claim 1, wherein machine learning models comprise:
a Recurrent Neural Network (“RNN”), a Temporal Convolution Network (“TCN”), or a Long Short-Term Memory (“LSTM”), and wherein the RNN, TCN, or LSTM receives the device data, the regional utility data, and the energy consumption data; and
a Deep Q Network (“DQN”), and wherein the DQN receives the device data, the regional utility data, and the energy consumption data.

4. The method of claim 1, wherein the machine learning model for gathering data about home devices is a natural language processing model and detecting inefficient devices further comprises:
determining which devices use the most energy using the time series deep learning model or the reinforcement learning model; and
predicting utility costs per device throughout the year using the time series deep learning model or the reinforcement learning model.

5. The method of claim 1, wherein performing a cost/benefit analysis for potential device upgrades comprises:
generating a list of candidate device sets;
predicting the expected energy efficiency of the device sets using the time series deep learning model or the reinforcement learning model; and
ranking the sets by weighing the savings in energy efficiency versus the installation costs of the candidate devices.

6. A computer system for optimizing home energy efficiency and device upgrade scheduling, the method comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
gathering utility data for a home;
training a machine learning models based on the gathered data;
detecting inefficient devices and utility configurations based on the trained machine learning model;
training a machine learning model to gather data about current and future advances in home device technology;
determining candidate device and utility upgrades;
performing a cost/benefit analysis based on the determined device and utility upgrades; and
providing a recommended device and utility upgrade schedule to the user.

7. The computer system of claim 6, wherein utility data comprises:
device data including manufacturer and model names of current home devices entered by a user;
regional utility data on available utilities at the home, utility costs and relevant government policies, and weather and natural disaster patterns; and
energy consumption data on hourly energy consumption rates for each utility used at the home.

8. The computer system of claim 6, wherein machine learning models comprise:
a Recurrent Neural Network (“RNN”), a Temporal Convolution Network (“TCN”), or a Long Short-Term Memory (“LSTM”), and wherein the RNN, TCN, or LSTM receives the device data, the regional utility data, and the energy consumption data; and
a Deep Q Network (“DQN”), and wherein the DQN receives the device data, the regional utility data, and the energy consumption data.

9. The computer system of claim 6, wherein the machine learning model for gathering data about home devices is a natural language processing model and detecting inefficient devices further comprises:
determining which devices use the most energy using the time series deep learning model or the reinforcement learning model; and
predicting utility costs per device throughout the year using the time series deep learning model or the reinforcement learning model.

10. The computer system of claim 6, wherein performing a cost/benefit analysis for potential device upgrades comprises:
generating a list of candidate device sets;
predicting the expected energy efficiency of the device sets using the time series deep learning model or the reinforcement learning model; and
ranking the sets by weighing the savings in energy efficiency versus the installation costs of the candidate devices.

11. A computer program product for optimizing home energy efficiency and device upgrade scheduling, the method comprising:
one or more non-transitory computer-readable storage media and program instructions stored on at least one of the one or more tangible storage media, the program instructions executable by a processor to cause the processor to perform a method comprising:
gathering device data, regional utility data, and energy consumption data for a home;
training a machine learning model based on the gathered data, wherein the machine learning model is a time series deep learning model or a reinforcement learning model;
detecting inefficient devices, and utility configurations based on the trained machine learning model;
training a machine learning model to gather data about current and future advances in home device technology;
determining candidate device and utility upgrades;
performing a cost/benefit analysis based on the determined device and utility upgrades; and
providing a recommended device and utility upgrade schedule to the user.

12. The method of computer program product of claim 11, wherein utility data comprises:
device data including manufacturer and model names of current home devices entered by a user;
regional utility data on available utilities at the home, utility costs and relevant government policies, and weather and natural disaster patterns; and
energy consumption data on hourly energy consumption rates for each utility used at the home.

13. The computer program product of claim 11, wherein machine learning models comprise:
a Recurrent Neural Network (“RNN”), a Temporal Convolution Network (“TCN”), or a Long Short-Term Memory (“LSTM”), and wherein the RNN, TCN, or LSTM receives the device data, the regional utility data, and the energy consumption data; and
a Deep Q Network (“DQN”), and wherein the DQN receives the device data, the regional utility data, and the energy consumption data.

14. The computer program product of claim 11, wherein the machine learning model for gathering data about home devices is a natural language processing model and detecting inefficient devices further comprises:
determining which devices use the most energy using the time series deep learning model or the reinforcement learning model; and
predicting utility costs per device throughout the year using the time series deep learning model or the reinforcement learning model.

15. The computer program product of claim 11, wherein performing a cost/benefit analysis for potential device upgrades comprises:
generating a list of candidate device sets;
predicting the expected energy efficiency of the device sets using the time series deep learning model or the reinforcement learning model; and
ranking the sets by weighing the savings in energy efficiency versus the installation costs of the candidate devices.
